(19) United States
(12) Patent Application Publication
(10) Pub. No.: US 2024/0337335 A1
(43) Pub. Date: Oct. 10, 2024

(54) CONNECTION PIECE FOR PIPES

(71) Applicant: Sanha GmbH & Co. KG, Essen (DE)

(72) Inventors: Geert Van den Abbeele, Kyllburg (DE); Tom Herberg, Maslchwitz (DE)

(73) Assignee: Sanha GmbH & Co. KG, Essen (DE)

(21) Appl. No.: 18/700,039

(22) PCT Filed: Jun. 8, 2022
(86) PCT No.: PCT/EP2022/065540

§ 371 Date: Apr. 10, 2024

(30) Foreign Application Priority Data
Oct. 21, 2021 (EP) EP21203867

(51) Int. Cl. F16L 13/14; F16L 5/04

(52) U.S. Cl. CPC F16L 13/142; F16L 5/04

(57) ABSTRACT

A connecting piece is made of metal for conduits, with a cylindrical, tubular receiving section into which a conduit section is insertable receiving section is at least partially designed as a pressing section and a first corrugation is formed on its inside. An elastic sealing member is placed in the first corrugation. Intumescent material is arranged at least in sections on the inside of the receiving section.

The invention relates to a metal connecting piece for conduits. In particular, the invention relates to a connecting piece for conduits with at least one cylindrical, tubular receiving section into which a conduit section is insertable. The receiving section is at least partially formed as a deformable pressing section. At least a first, preferably annular corrugation is formed in the pressing section along an inner circumference of the connecting piece and an elastic sealing means is placed in the first corrugation, which at least partially fills the corrugation. In the context of this application, the term “annular” is to be understood as meaning that a closed (endless) corrugation with any desired profile is formed along the inner circumference of the connecting piece. The cross-section of the profile can be rounded, angular or otherwise geometrically shaped.

Connecting pieces of this type are also known as press fittings. Press fittings of this type are made from various metals, for example stainless steel, other types of steel, copper or cast materials. Press fittings enable conduits to be connected in the form of straight connections or by providing changes of direction or diameter. Branches and separation points can also be provided by such press fittings. To make the connection, a pipe is inserted into a tubular receiving section of the connecting piece and then the connecting piece is plastically deformed in the area of the corrugation with the inserted sealing means using a pressing tool. For this purpose, the pressing tool can engage next to the corrugation or also deform the corrugation itself or reach over the corrugation and cause plastic deformation on both sides of the corrugation. The crimped connection closes the annular space between the inserted pipe and the connecting piece and the sealing means, e.g. in the form of an elastomer seal, permanently seals this crimped connection.

The tightness of these connections is produced by the pressing process. The combination of pipe, sealing means and fitting, which is initially produced by insertion into each other, does not leak before pressing. This leakage is desirable as it enables the installer to detect leaks that have not been pressed at all or not completely when carrying out a pressure test. Accordingly, the sealing means does not seal against the pipe and/or fitting in the non-pressed state, but provides space for a desired leak. When the fitting is pressed, this “leak path” is permanently closed and the connection is permanently sealed.

Connecting pieces that are suitable for producing a connection of the type mentioned are known, for example, from document DE 195 09 586 C1 or document DE 102005 043 238 A1.

The aim of crimped connections is to create a permanently sealed connection. However, under the influence of extreme environmental conditions, in particular in the event of fire or when exposed to excessive heat, leaks can occur in the area of the crimped connection.

The task of the invention is to enable durable crimped connections under extreme conditions by providing an improved connecting piece.

This task is solved by a connecting piece made of metal with the features of patent claim 1 and a connecting system with the features of patent claim 17.

According to the invention, the connecting piece has areas in the receiving section, at least in sections, in which an intumescent material, in particular an expandable graphite material, is arranged.

According to the above explanation, the receiving section serves to receive a tubular part when a connection is made, so that an annular gap is formed between the connecting piece, which has a free diameter for receiving the conduit, and the inserted conduit. The sealing means is located in this connecting section. In addition, intumescent material, in particular expandable graphite, is arranged in this connecting section. Depending on the area of application, intumescent materials are also referred to as intumescent coating formers. Intumescent material (also known as intumescenting material), in particular expandable graphite, is a material that is used in fire protection due to its flame-retardant effect. This property is known as “intumescence”. Expandable graphite is a particularly common and cost-effective intumescent material. The processing of graphite into expandable graphite incorporates other substances or compounds into the layered lattice structure of graphite, which drive the layers of the graphite lattice structure apart when exposed to heat, so that the material expands when exposed to heat. The resulting expansion is considerable and can reach up to 600 times the initial volume in terms of the final volume. This increase in volume means that in the event of fire, free spaces can be blocked for gaseous and liquid fluids or flashover (fluids are defined below as any gaseous or liquid substance). Furthermore, a very large surface is formed, which enables rapid oxidation of the carbon, so that the oxygen in this area is removed from the combustion air through oxidation. This also promotes flame retardancy.

However, there are also other intumescent materials that can be used in an equally effective and equivalent manner. For example, intumescent materials are known, e.g. in the field of steel coating, which contain polyvalent alcohol (usually pentaerythritol), and also usually melamine and a phosphorus donor (e.g. ammonium polyphosphate). Ammonium polyphosphate (APP) decomposes at temperatures above 250° C. to form phosphoric acid, which reacts with pentaerythritol to form phosphate esters, which decompose further to form carbon dioxide and carbon and phosphorus-containing residues. When heated, the melamine decomposes to form gaseous ammonia, which leads to the expansion of the ammonium polyphosphate residues. This produces a heat-insulating foam.

Intumescent material, in particular expandable graphite, can be produced and purchased on the market in a wide variety of material forms, in particular as powder or flakes, as well as moulded bodies or flat coatings or as paint. These materials can easily be used to create a material depot for the expandable graphite in the connecting piece according to the invention. The connecting piece can be used in the same way as the previous press fittings without special consideration of the intumescent insert, in particular the expandable graphite insert, but the placement of an intumescent material depot achieves a significantly improved flame retardant effect. By placing intumescent material in the receiving section, the annular gap between the inserted pipe and the connecting piece is sealed in the event of fire, i.e. when this intumescent material heats up. Due to the expansion of the intumescent material, self-tensioning of the system is achieved so that the annular gap is largely sealed. Due to the small volume to be filled in the annular gap and the above-mentioned considerable volume expansion of the intumescent material, tightness can be guaranteed even in the event of prolonged exposure to heat through post-expansion.

Although the intumescent material, in particular expandable graphite, is always at least partially located in the receiving section, it is not absolutely necessary to place all of the intumescent material in this section. In particular, it is also not necessary (although possible) for the intumescent material to be located in the area of the receiving section that serves as the pressing section. The intumescent material can therefore be placed in receiving section areas that do not serve as a pressing section, but it can also be arranged, at least partially, in the pressing section and, in addition, parts of the intumescent material can also be placed outside the receiving section.

An easy-to-use connecting piece is thus produced, which can be processed by the user in the same way and used to produce a crimped connection as conventional connecting pieces for producing crimped connections. The considerable added benefit of the flame protection is provided automatically during assembly without any further intervention, as the deposits of the intumescent material, in particular expandable graphite deposits, are placed together with the connecting piece in a fixed position in the connecting piece in such a way that they are optimally positioned to seal the annular gap when the crimped connection is made.

In a preferred embodiment of the invention, the intumescent material, in particular intumescent material, in particular expandable graphite, is placed at least partially in recesses in the inside of the connecting piece.

According to this embodiment, both the sealing means is located in an associated corrugation in the receiving section and the intumescent material is located in at least one recess.

As described above, intumescent material can be present in a wide variety of material forms (e.g. as powder or flakes as well as moulded bodies or flat overlays or as paint). A material deposit of the intumescent material can be easily created from these materials in assigned recesses in the connecting piece. Placement in recesses allows the formation of a particularly voluminous material depot. In addition, placement in recesses protects the intumescent material during normal operation and when setting up the connecting piece, so that an inserted conduit section cannot remove the intumescent material.

When the term recess is used in the context of the present invention, it refers to material-free areas, e.g. on the inside of the connecting piece, which are formed by deformation or material removal. These material-free areas are therefore recesses in the continuous wall of the connecting piece and are designed in particular in such a way that an inserted pipe cannot penetrate into these areas with a bracing or shearing effect, so that the expanded graphite deposit placed therein is protected from inserted pipes and mechanical action.

The position, design and geometry of the recesses into which the intumescent material, in particular expandable graphite, is placed depend on the shape in which the expandable graphite is placed in the recesses. If, for example, the size and contour of a body made of intumescent material is adapted to the connecting piece and placed in the connecting section, a corresponding annular recess can be placed in the connecting piece. This recess can also be formed by the first corrugation, so that the sealing means and intumescent material are accommodated in a common recess, namely the corrugation. Alternatively, however, interrupted or uninterrupted areas of recesses can also be made on the inside of the connecting piece in the connecting section, which are filled with expandable graphite powder, possibly with the addition of an adhesion promoter.

It is particularly preferable if the recesses, which are at least partially filled by the expandable graphite, are formed by the same first corrugation in which the sealing means is placed.

According to this embodiment, the already existing corrugation, which receives the elastic sealing means for sealing the crimped connection, is also used to receive at least part of the expandable graphite. The intumescent material (in particular expandable graphite) can be placed as a base, as it were, before the sealing means is inserted into the corrugation, or it can be placed next to the sealing means in one or both of the lateral extensions of the corrugation. The edge areas of a corrugation, where the wall material merges back into a straight wall, are usually not filled with the sealing means, so that these areas can be used to generously accommodate the intumescent material (especially expandable graphite). The intumescent material can be spread in these areas or it can be inserted into these areas as a ring or film.

In principle, it is also possible to partially widen the first corrugation in the lateral area, i.e. offset in the axial direction of the connecting piece relative to the inserted seal, in order to provide a larger receiving area for the intumescent material.

It is particularly advantageous if the intumescent material is arranged in the first corrugation between the sealing means and the wall material of the connecting piece.

In this area, the intumescent material is protected by the sealing means as long as the connecting piece does not heat up, which would lead to expansion of the intumescent material. If a fire does occur, the expanding effect of the intumescent material initially presses the sealing means against the inner conduit as long as possible, even providing thermal insulation from the outer skin through the expanding intumescent material. In this way, the sealing means is supported longitudinally in its sealing effect. If the sealing means is then ineffective due to thermal decomposition, its space is taken up by the expanding intumescent material.

According to an advantageous further development of the invention, a claw ring is arranged in the pressing section on the inside of the receiving section.

Claw rings are used to secure pipe connections, in particular against tensile effects in the direction of the pipe. Various designs of claw rings are known, e.g. incisive, interlocking or flat contoured and thus surface-protecting claw rings. The use of claw rings in combination with intumescent material according to the invention ensures increased securing of the connection under mechanical and also simultaneous thermal stress.

In a further development of the invention, the intumescent material is arranged adjacent to the claw ring or inside the claw ring.

The direct combination of claw ring and intumescent material results in a space-saving arrangement and protection of the intumescent material by the robust claw ring. If the claw ring has two cutting edges that delimit an intermediate area, the intumescent material can be placed in this annular space, which is protected by the claw ring after pressing, as it cuts into the inserted pipe with the comprehensive cutting edges and thus encapsulates the intumescent material between the claw ring and the inserted pipe. The intumescent material can thus be largely protected from contact with the environment and the guided fluid.

It is advantageous if the intumescent material and the claw ring are arranged together with the elastic sealing means in the first corrugation.

The arrangement in a common corrugation enables a more compact design and faster assembly through the combined insertion of several components.

In a further development of the invention, a support ring is arranged next to the elastic sealing means, wherein the support ring consists at least partially of intumescent material (in particular expandable graphite) or is coated with intumescent material.

Support rings are proven means of protecting sealing means, in particular annular seals, from destruction under high pressure. They prevent excessive deformation of the sealing means, e.g. into the sealing gap. Forming a support ring at least partially from intumescent material further reduces the installation space and weight of the connecting piece. The intumescent material can take the form of an insert, overlay or coating of the support ring. The support ring can also be made of intumescent material or consist of a combination of intumescent material and other materials. For example, support rings made of steel, stainless steel or copper alloy with a complete or partial coating of intumescent material can be used.

In an alternative embodiment of the invention, the intumescent material is arranged in at least one second corrugation, which is formed in the connecting piece offset in the axial direction of the receiving section.

In this embodiment, a second corrugation is thus specifically formed for the intumescent material in the connecting piece, which may well be different from the first corrugation in terms of its geometry and dimensions. Such a corrugation can be easily produced using appropriate moulding tools and provides a receiving space in which both intumescent material in powder or flake form, possibly mixed with an adhesion promoter, and intumescent material in the form of preformed bodies, for example as rings, can be inserted.

In a further development of this embodiment of the invention, the first corrugation can be formed adjacent to the second corrugation, so that the corrugations merge into one another and a double corrugation is formed, of which one part of the corrugation is filled by a sealing means and the other part of the corrugation is partially filled by intumescent material.

Particularly in the design with a corrugation as a receptacle for the intumescent material, but also in other designs, it is particularly advantageous if the intumescent material is at least partially inserted as an annular body in an associated recess.

The placement of such a prefabricated body ensures a radially continuous placement of the intumescent material along the entire circumference of the connecting piece and an extremely even distribution of the intumescent material.

In another preferred embodiment of the invention, the intumescent material is placed in the connecting piece as a film, with the film being placed in an associated recess, for example an area of the corrugation or areas with other recesses.

It is particularly preferable if the recesses in which the intumescent material is placed in the connecting area are formed by profiling and/or roughening the inside of the connecting piece in the receiving section.

The aforementioned document DE 10 2005 043 238 A1 describes a connecting piece with a roughened inner area in order to increase the coefficient of friction between the connecting piece and the inserted conduit after the crimped connection has been made. This mechanically secures the connection by creating a positive connection between the roughened area and the inserted conduit. The simultaneous use of the existing roughening or profiling of the inner areas provides both mechanical protection and the additional benefit of fire protection at the same time. When the crimped connection is made, the material of the surrounding connecting piece and the inserted conduit are partially interlocked in the roughened or profiled areas. If intumescent material is arranged in the recesses of the profiled areas in the connecting piece, this is trapped in the interlocked area as a deposit between the two components and develops its particularly effective sealing effect at this point when exposed to heat.

In a preferred embodiment of the invention, the intumescent material is arranged at least partially as a spray application or brush application (also in the form of a paint) on the connecting piece. In particular in combination with the variant one internal profiling, a spray application of the intumescent material can ensure a distributed and economical placement of the intumescent material, in which even the smallest recesses can be filled with intumescent material. This achieves an economical, extensive and particularly effective seal over a larger axial section of the connecting piece.

In a further development of the invention, the intumescent material is not only applied in the connecting area, but at least partially in the area of the connecting piece adjacent to the end of the receiving section, so that when a conduit section is inserted, the intumescent material is adjacent to one end of the inserted conduit section.

Placing a deposit of intumescent material in the area where the pipe end comes to rest when the crimped connection is made can seal the end face of the annular gap between the connecting piece and the inserted conduit in the event of a fire. Furthermore, it is even possible that a deposit of intumescent material in this area, in view of its considerable expansion in the event of fire, reduces the overall pipe cross-section, i.e. not only seals the annular gap, which is caused by the intumescent material in the connection area, but even causes a reduction in the pipe cross-section, which is formed by the connecting piece itself, i.e. beyond the end face of an inserted pipe.

In a modification of the invention, the sealing means is connected to the intumescent material to form an integral component. The sealing means can, for example, be in the usual form as an annular seal, but with an inner annular core of intumescent material completely surrounded by the elastic material. When exposed to heat and decomposition of the elastic sheath material of the sealing means, the inner core of intumescent material expands and occupies the space of the destroyed sealing means. The core of intumescent material does not have to be formed continuously, but can also consist of coated, distributed deposits or grains or particles of intumescent material that are incorporated into the sealing means.

In a modification, intumescent material can also be arranged on the surface of the sealing means to form an integral component, so that the sealing means is at least partially coated with intumescent material or coated with it. The integral combination of sealing means and intumescent material allows for particularly easy assembly and arrangement, as correct placement of the intumescent material is ensured at all times.

A further modification of the invention relates to a connecting system in which, however, the intumescent material is not arranged in the fitting but on the outer circumference of the conduit section which is inserted into the fitting. Accordingly, a connecting system for conduits made of metal is then provided, in which a connecting piece has at least one cylindrical, tubular receiving section, wherein the receiving section is at least partially formed as a deformable pressing section. A conduit section of the connection system is insertable into the tubular receiving section. In the receiving section, at least one first annular corrugation is formed on the inside of the connecting piece along an inner circumference of the connecting piece, into which an elastic sealing means is placed, which at least partially fills the corrugation. In this modification of the invention, intumescent material is arranged at least in sections on the outside of the conduit section in the region which is insertable/inserted into the receiving section, wherein the intumescent material is arranged at least partially in recesses in the outside of the conduit section or is applied as a paint application or spray application on the outside of the conduit section.

The invention will now be explained in more detail with reference to the accompanying drawing:

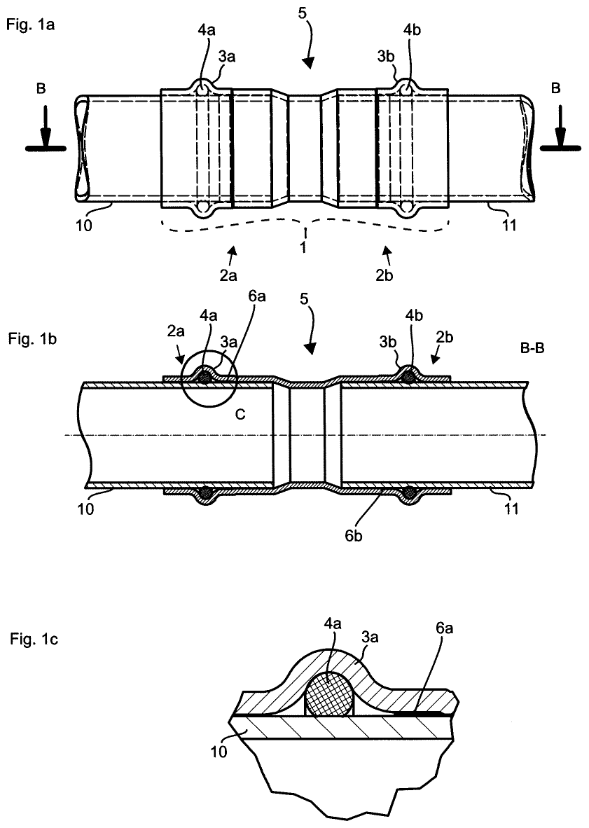

FIGS. 1a, 1b and 1c show a first embodiment in a schematic, partially transparent view, a sectional view and a detailed enlargement of the sectional view;

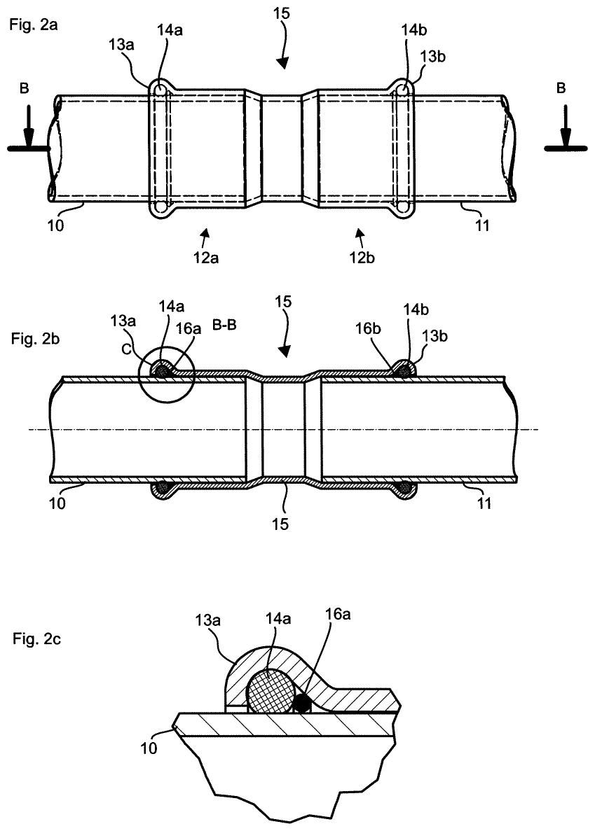

FIGS. 2a, 2b and 2c show a second embodiment in a schematic, partially transparent representation, a sectional view and a detailed enlargement of the sectional view;

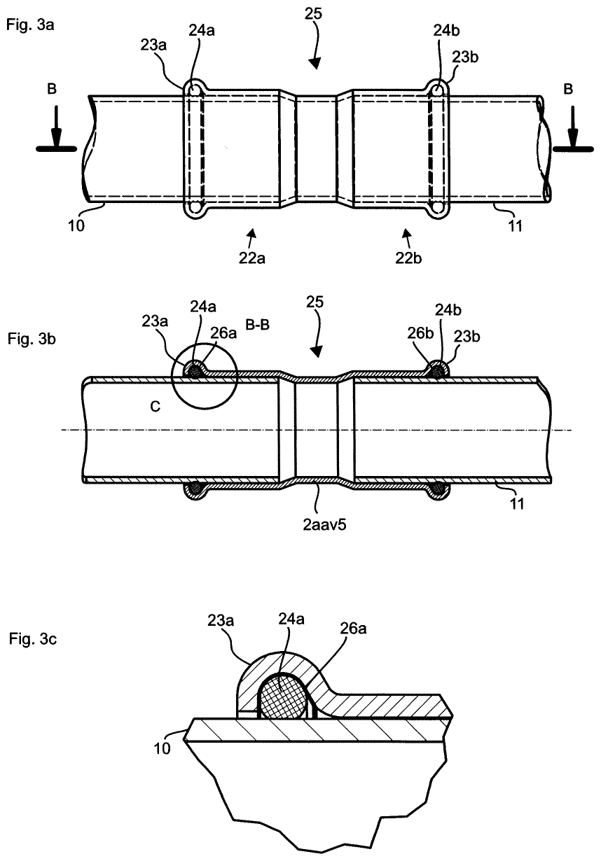

FIGS. 3a, 3b and 3c show a third embodiment in a schematic, partially transparent representation, a sectional view and a detailed enlargement of the sectional view;

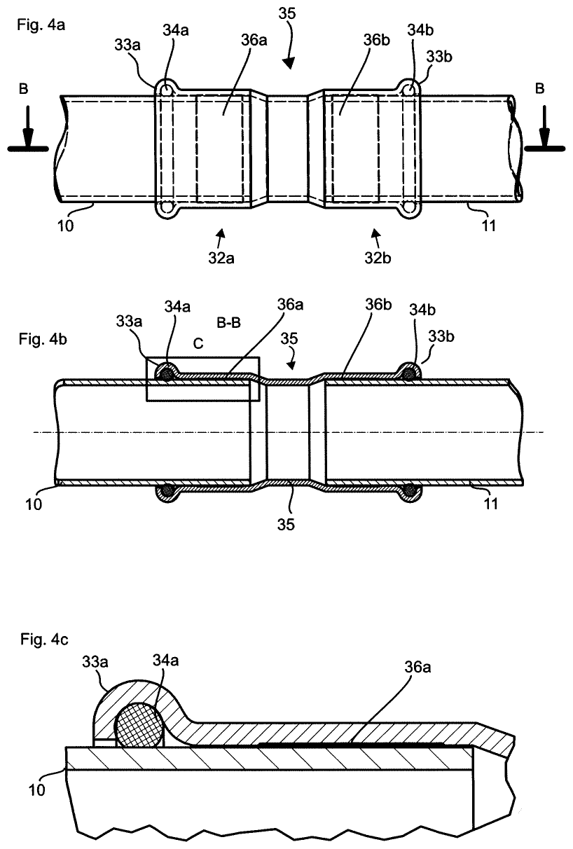

FIGS. 4a, 4b and 4c show a fourth embodiment in a schematic, partially transparent representation, a sectional view and a detailed enlargement of the sectional view;

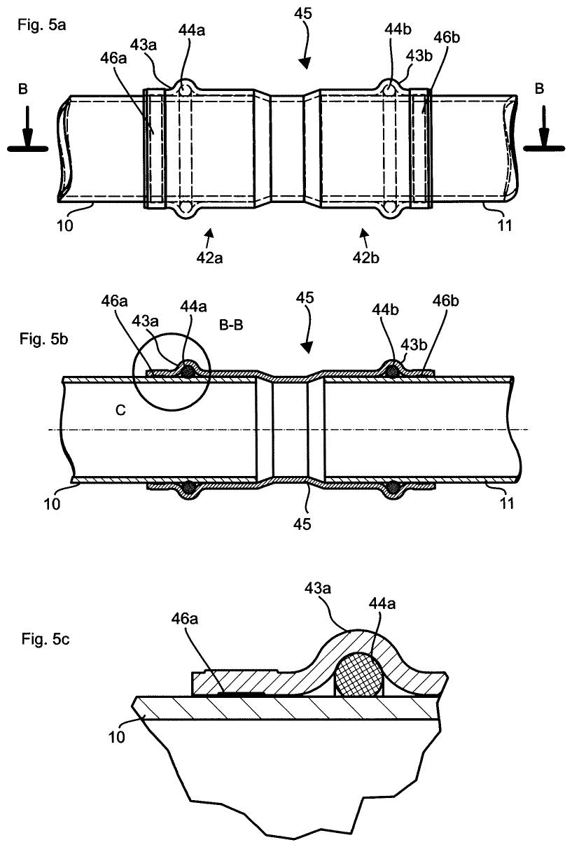

FIGS. 5a, 5b and 5c show a fifth embodiment in a schematic, partially transparent representation, a sectional view and a detailed enlargement of the sectional view;

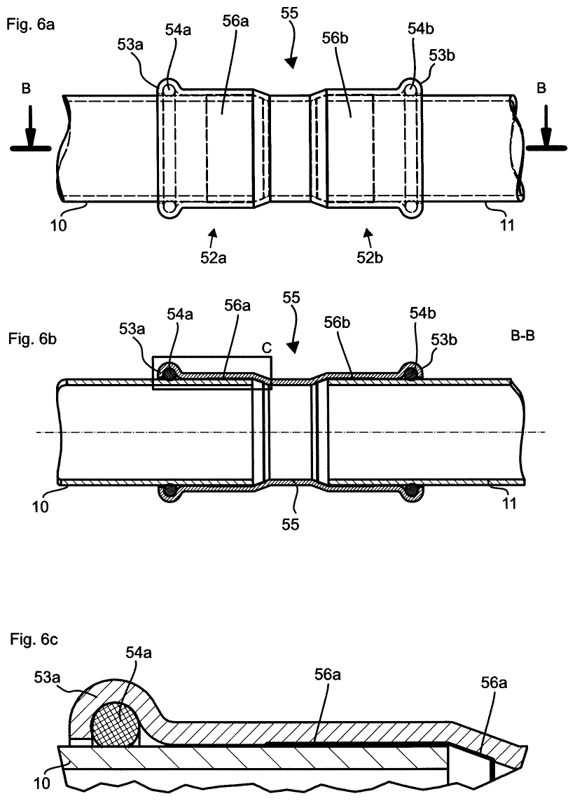

FIGS. 6a, 6b and 6c show a sixth embodiment in a schematic, partially transparent representation, a sectional view and a detailed enlargement of the sectional view;

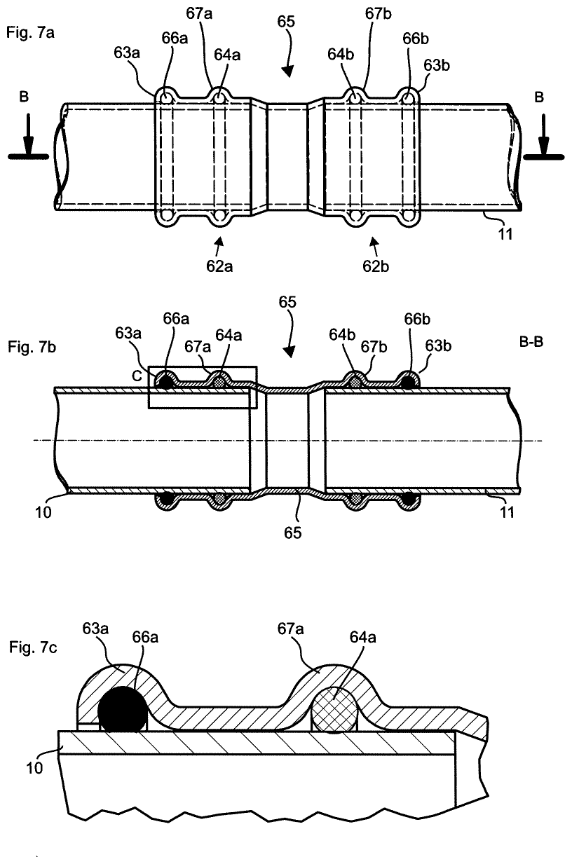

FIGS. 7a, 7b and 7c show a seventh embodiment in a schematic, partially transparent representation, a sectional view and a detailed enlargement of the sectional view;

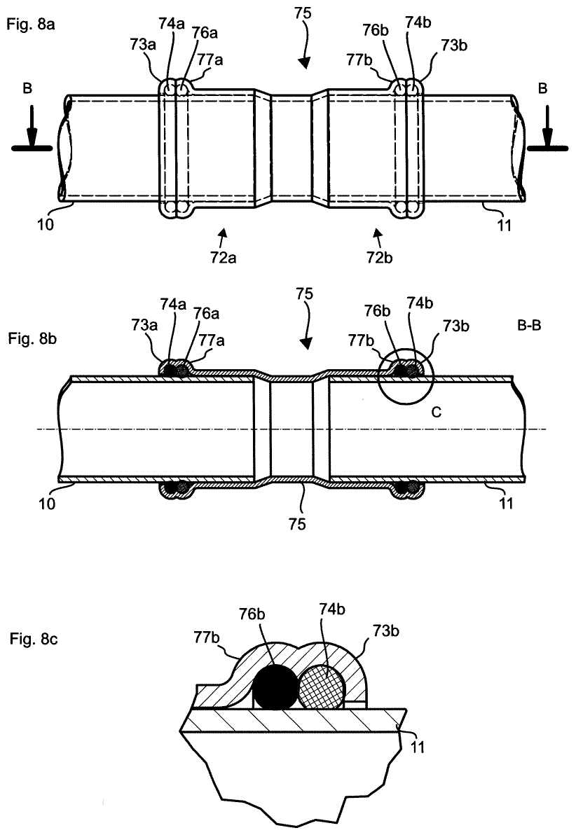

FIGS. 8a, 8b and 8c show an eighth embodiment in a schematic, partially transparent representation, a sectional view and a detailed enlargement of the sectional view;

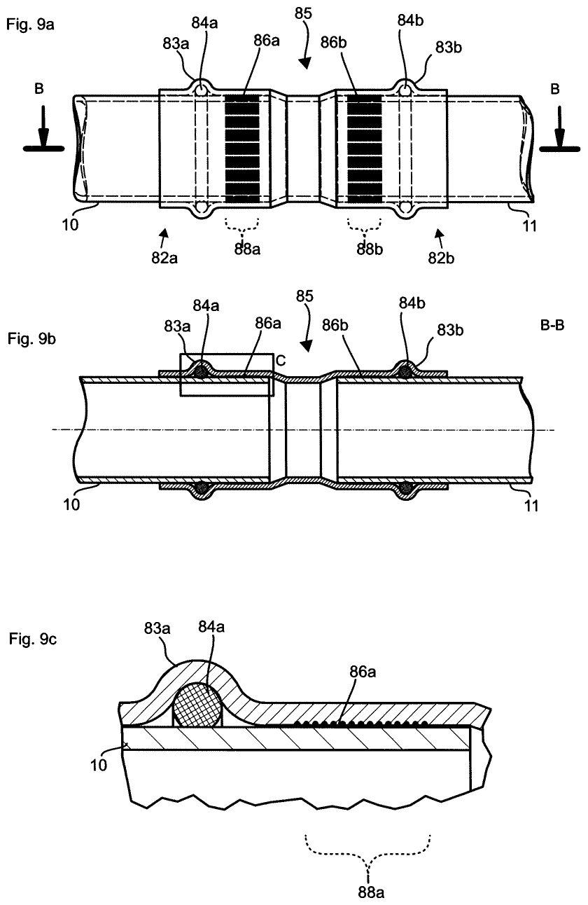

FIGS. 9a, 9b and 9c show a ninth embodiment in a schematic, partially transparent representation, a sectional view and a detailed enlargement of the sectional view;

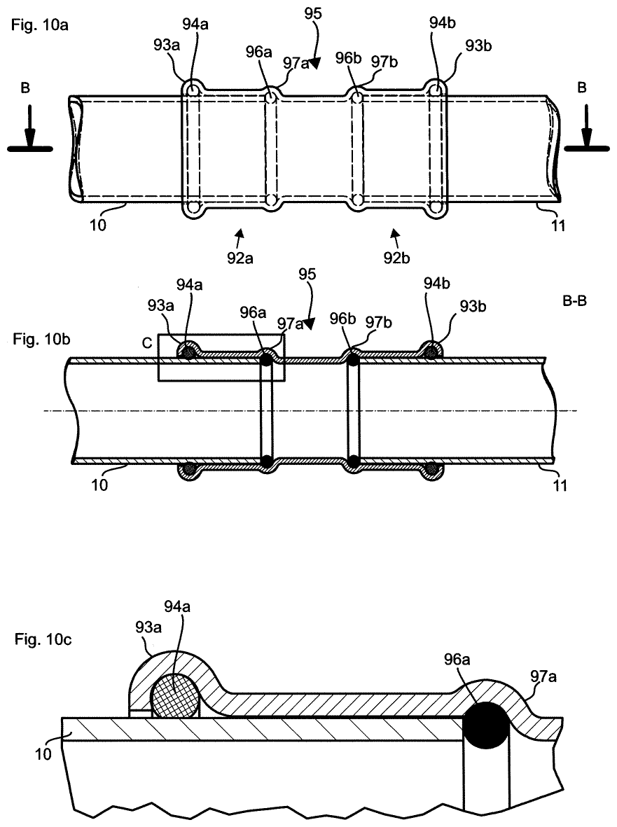

FIGS. 10a, 10b and 10c show a tenth embodiment in a schematic, partially transparent representation, a sectional view and a detailed enlargement of the sectional view.

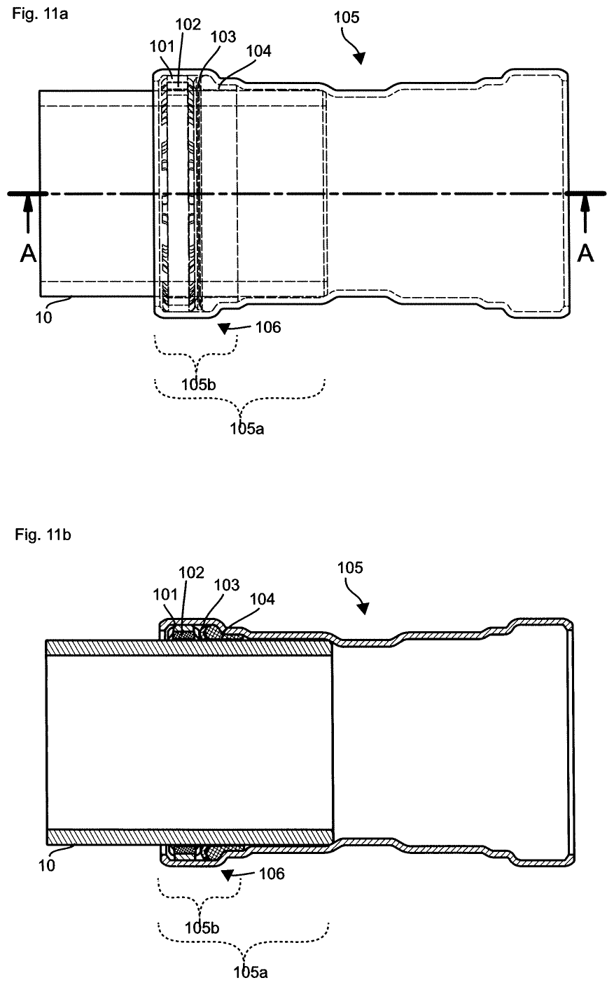

FIGS. 11a and 11b show an eleventh embodiment in a schematic, partially transparent representation and a sectional view.

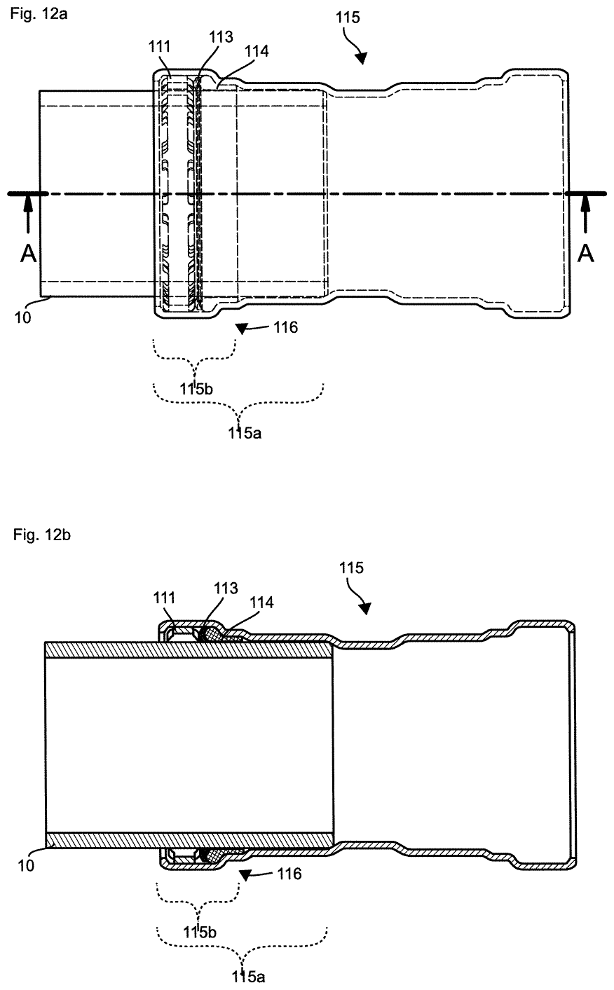

FIGS. 12a and 12b show a twelfth embodiment in a schematic, partially transparent representation and a sectional view.

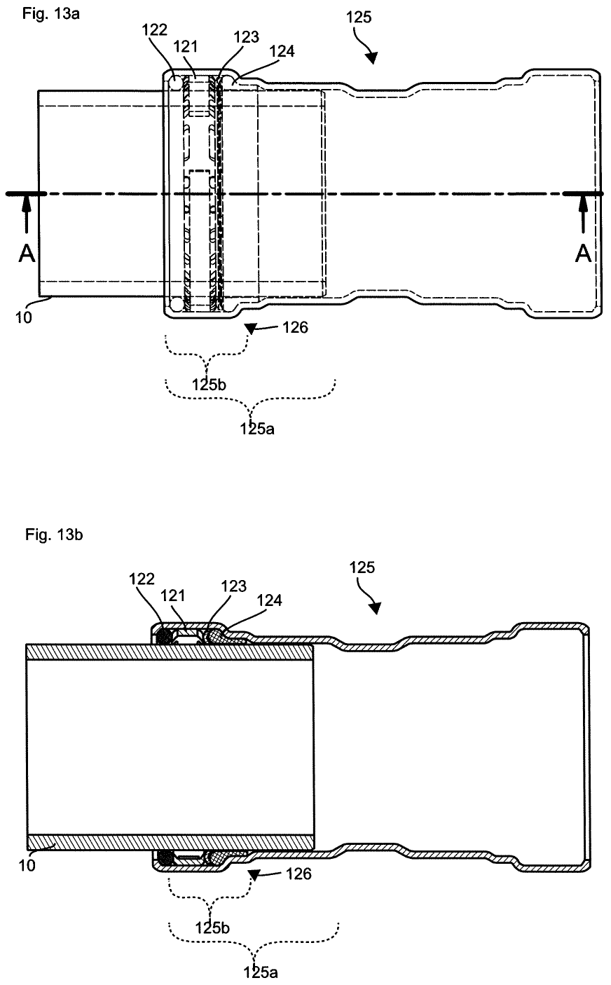

FIGS. 13a and 13b show a thirteenth embodiment in a schematic, partially transparent representation and a sectional view.

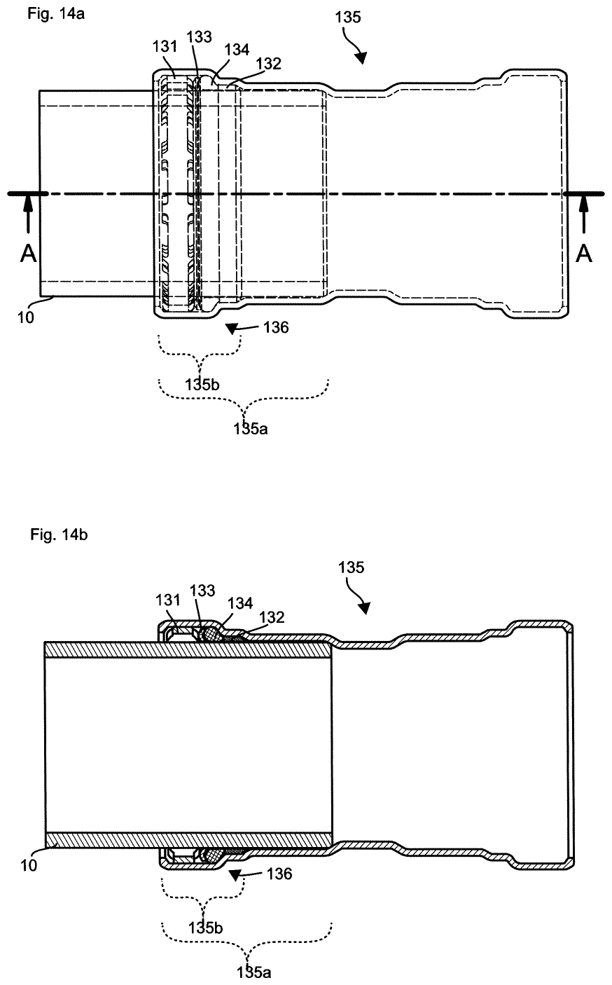

FIGS. 14a and 14b show a 14th embodiment in a schematic, partially transparent representation and a sectional view.

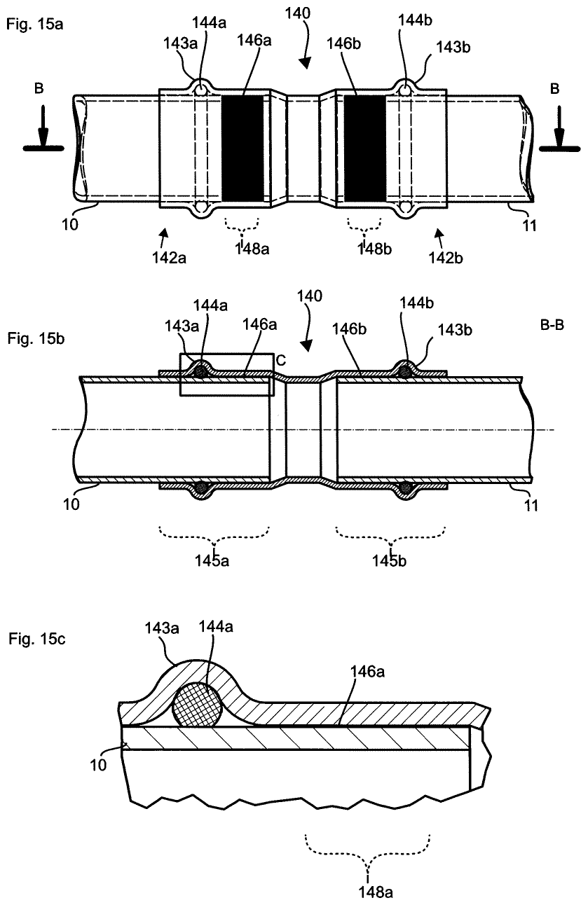

FIGS. 15a, 15b and 15c show a 15th embodiment in a schematic, partially transparent representation, a sectional view and a detailed enlargement of the sectional view;

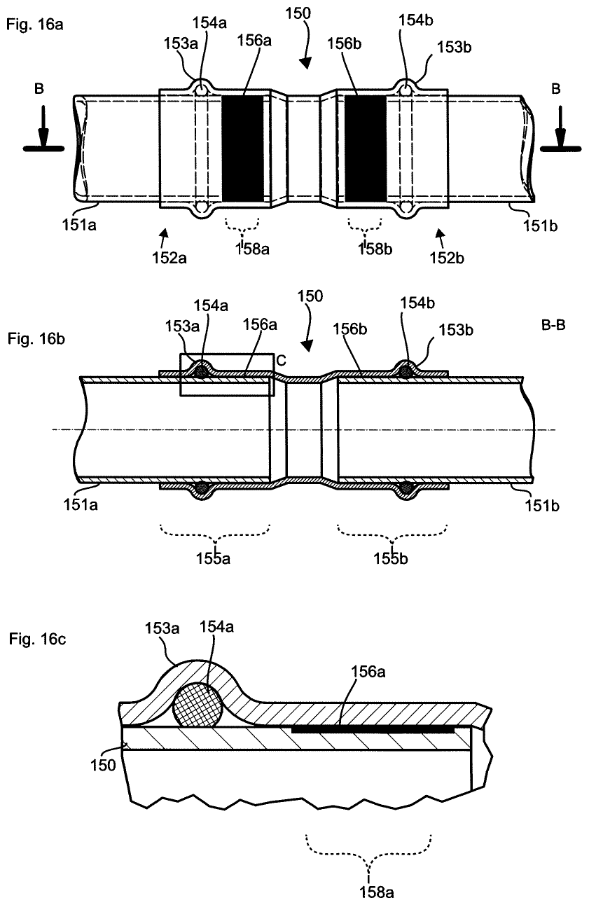

FIGS. 16a, 16b and 16c show a 16th embodiment in a schematic, partially transparent representation, a sectional view and a detailed enlargement of the sectional view;

The following embodiment examples show numerous designs for embodiments of the invention, whereby in these examples the use of exfoliated graphite as intumescent material is taken as a basis. However, depending on requirements, cost efficiency and availability, other intumescent materials can also be used in accordance with the above explanation.

FIGS. 1a, 1b and 1c show a first embodiment of the invention. A connecting piece 1 according to the invention has two cylindrical sections 2a, 2b facing away from each other. These are connected at the ends facing each other by a constricted region of the connecting piece 5. A corrugation 3a, 3b is formed in each of the receiving sections 2a, 2b. An elastic sealing means 4a, 4b is in turn inserted into each of these corrugations 3a, 3b. The illustration shows two conduit sections 10 and 11, which are each inserted into the receiving sections 2a and 2b of the connecting piece 1. The conduit sections 10 and 11 are inserted into the respective receiving sections 2a and 2b until they come to rest against corresponding stops in the area of the constriction of the connecting piece 5 due to the narrowed diameter.

In this state, the sealing means 4a and 4b lie against the inserted conduit sections 10 and 11 along their circumference and seal the annular space, whereby a crimped connection between the connecting piece 1 and the conduit sections 10 and 11 is achieved by plastic deformation of the receiving sections 2a and 2b. The sections 2a and 2b thus clamp the inserted conduit sections 10 and 11 and connect them to form a continuous fluid connection.

FIG. 1b shows a sectional view of the arrangement from FIG. 1a along the marked sectional plane. FIG. 1c shows a detailed enlargement of an area marked by a circle in FIG. 1b.

In this first embodiment example, foil layers 6a, 6b made of expandable graphite are each placed in an edge region of the corrugations 3a and 3b. The foil layers 6a, 6b are placed as a thin layer of material in an extension of the bead deformation as a recess. In this embodiment example, the film layers 6a, 6b are arranged on the side of the respective corrugations 3a, 3b facing the connection side. Depending on the placement of the film layers 6a and 6b, no deformation of the material in the area of the corrugation beyond the usual geometry of the corrugation is required, provided that the film layer is moved close enough to the central corrugation moulding, as a recess is then formed by the lateral extensions of the corrugation anyway. Alternatively, as can be seen in FIG. 1c, a recess can be created by removing a small amount of material in the edge area of the corrugation in which the film layers 6a or 6b are inserted.

The other embodiments are described without repeating the description of the production of a crimped connection with the inserted conduits 10 and 11, as this is not important for the invention. The above applies mutatis mutandis to these embodiments.

FIGS. 2a, 2b and 2c show a second embodiment of a connecting piece 15, wherein the expandable graphite is inserted as an annular body 16a into a corrugation 13a at the end of the connecting piece, which also accommodates the sealing means 14a. Sealing means 14a and expandable graphite 16a are arranged directly adjacent to each other in the same end corrugation and in this way form a sealing composite, whereby the annular material 16a expands in the event of fire and completely fills the space of the corrugation 13a when the sealing material 14a is thermally decomposed. On the opposite side, a corresponding corrugation 13b is formed with sealing means 14b and expandable graphite 16b.

In this example, the expandable graphite in the form of the annular material 16a is arranged on the side of the sealing material 14a facing away from the insertion side, but an arrangement on the side of the sealing means 14a facing the insertion side is also possible.

FIGS. 3a, 3b, 3c show a third embodiment of the invention in the form of a connecting piece 25. In this embodiment, the expandable graphite is inserted as a foil 26a between the material of the corrugation 23a and the sealing material 24a and is fixed in position by the sealing material 24a. In this configuration, thermal decoupling can take place between the sealing material 24a and, for example, a heat source in the environment when the expandable graphite expands in the foil material 26a. On the opposite side, a corresponding corrugation 23b is formed with sealing means 24b and expandable graphite 26b.

FIGS. 4a, 4b and 4c show a connecting piece 35 with two end sides, but in this example the expandable graphite is inserted as foil material 36a, 36b in an associated recess, which in this example is formed as an annular groove, at a distance from the corrugations 33a, 33b. The groove-shaped recesses for the expandable graphite material are formed by milling or a corresponding moulding tool. It can be seen in FIG. 4c that the recess and the placing of the foil 36a in the recess protects the expandable graphite from being scraped or sheared off by the inserted piece of pipe 10. The sealing means 34a, 34b in the corrugations 33a, 33b seal the annular space in the usual manner under normal operating conditions.

A fifth embodiment example of a connecting piece 45 according to the invention is shown in FIGS. 5a, 5b and 5c. There, the expandable graphite is placed as foil material 46a, 46b in a side of the sealing means 44a, 44b facing the insertion side of the respective connections. Accordingly, this is a modification of the fourth embodiment example with regard to the sequence of sealing means 44a, 44b and expandable graphite 46a, 46b.

FIGS. 6a, 6b and 6c show a sixth embodiment of the invention in the form of a connecting piece 55, wherein here foils 56a, 56b made of expandable graphite extend via associated recesses in the insertion region into the centre region of the connecting piece 55. The expandable graphite 56a, 56b is thus arranged both in the insertion area and there in a recess as well as in the area into which the inserted conduits 10, 11 do not project. In this way, expansion of the expandable graphite makes it possible both to seal the annular gap between the connecting piece and the inserted conduit sections 10, 11 and to narrow or even completely close the pipe cross-section for fluid flow, depending on the film thickness and expansion capacity of the expandable graphite.

FIGS. 7a, 7b and 7c show a connecting piece 65 according to a seventh embodiment example. In this embodiment example, two corrugations 63a, 67a or 63b, 67b are formed on each side, one of which receives the sealing means 64a, 64b and another of which receives a ring of expandable graphite 66a, 66b. In such a design, a larger quantity of expandable graphite can be accommodated by the bead formation, which can be particularly relevant in the case of special requirements for the durability of the flame protection. In this example, the rings of expandable graphite 66a, 66b are arranged in the corrugations closest to the respective insertion opening. However, the order of arrangement of the intumescent material on the one hand and the sealants on the other can be varied.

FIGS. 8a, 8b and 8c show a connecting piece 75 according to an eighth embodiment of the invention, in which double corrugations are formed by arranging two corrugations 77b, 73b and 77a, 73a directly next to one another. The double beads each accommodate the sealing means in the form of a sealing ring 74a, 74b and a ring 76a, 76b made of an expandable graphite material.

FIGS. 9a, 9b and 9c show a ninth embodiment of the invention, wherein in this embodiment the inside of the connecting piece 85 is roughened or contoured in the connecting area in sections 88a, 88b. Such roughening or contouring can, for example, be achieved by some type of material removal, for example also by cutting a thread or also by rolling a thread. The recesses in the sections 88a, 88b are filled with expandable graphite 86a, 86b, whereby there may also be interruptions and areas without expandable graphite in the circumferential direction, as FIG. 9a shows. In the case of high heat exposure, the expandable graphite 86a, 86b expands so considerably that even the areas without occupancy are covered by the expanding expandable graphite and flame protection is ensured. In this example, the corrugations 83a, 83b and their associated sealing means 84a, 84b are formed in the usual way.

FIGS. 10a, 10b and 10c show a tenth embodiment of the invention. In this embodiment, corrugations 97a, 97b are arranged at the end of the receiving sections of the connecting piece 95 in the region of the tapered cross-section of the connecting piece 95, a ring 96a, 96b of expandable graphite being inserted into each of these corrugations 97a, 97b. In this way, the expandable graphite is arranged in the end region of the receiving section and acts in this stop region for the inserted conduit section in such a way that, when heated, it both closes the annular gap between the connecting piece and the inserted conduit section and also narrows or completely closes the cross-section of the fluid passage as a whole. In this example, the corrugations 93a, 93b and their associated sealing means 94a, 94b are formed in the usual manner.

FIGS. 11a and 11b show an eleventh embodiment of the invention. In this embodiment, a claw ring 101 is arranged in the pressing section 105b on the inside of the receiving section 105a of the connecting piece 105.

As already described above, claw rings are used to secure pipe connections, in particular against tensile effects in the direction of the pipe. In this example, a claw ring 101 is shown with two circumferential cutting edges that comprise a centre area. A ring of expandable graphite 102 is arranged between the cutting edges and thus inside the claw ring 101. This combination of claw ring 101 and expandable graphite 102 results in a space-saving arrangement and protection of the expandable graphite 102 by the robust claw ring 101. When the claw ring cuts into the conduit 10 inserted into the receiving section 105a during the process of pressing the area 105b, the expandable graphite 102 is encapsulated between the claw ring 101 and the inserted conduit 10. The expandable graphite 102 is thus largely protected from contact with the environment and the guided fluid. A support ring 103 is arranged next to the claw ring 101 as well as an elastic sealing means 104, which is designed as a sealing ring with a sleeve. All components are arranged in a common corrugation, which extends with varying diameter over the area 105b. The arrangement in a common corrugation enables a compact design and rapid assembly through the combined insertion of several components.

FIGS. 12a, and 12b show a twelfth embodiment of the invention in the form of a connecting piece 115. In this design, a support ring 113 is arranged between the elastic sealing means 114 and the claw ring 111 in the pressing section 115b, wherein the support ring 113 consists wholly or partly of expandable graphite or is coated with expandable graphite. The support ring 113 prevents excessive deformation of the sealing means 114. The formation of the support ring 113 at least partially from expandable graphite further reduces the installation space and the weight of the connecting piece.

FIGS. 13a and 13b show a 13th embodiment of the invention with a connecting piece 125. In this embodiment, a claw ring 121 is provided next to a support ring 123 and a sealing ring 124 in the pressing section 125b. In this embodiment, an expandable graphite ring 122 is positioned in front of the claw ring in the direction of the egg thrust (whereby the sequence of the components can also be varied).

FIGS. 14a and 14b show a 14th embodiment of the invention. In this embodiment, a claw ring 131 is provided in the connecting piece 135 in addition to a support ring 133 and a sealing ring 134. In this design, the expandable graphite 132 is in ring form or as a foil or coating in the direction of the egg thrust behind the sealing ring 134 and is arranged in the end region of the pressing section 135b, in which the sleeve of the sealing ring 134 would be placed in the previous examples of FIGS. 11a to 13b.

FIGS. 15a, 15b and 15c show a 15th embodiment of the invention.

This embodiment is characterised by the fact that recesses for receiving the intumescent material in the connecting piece have been dispensed with. Although corrugations 143a and 143b are again provided on the connecting piece 140 in its insertion areas 145a, 145b, in which associated sealing means 144a, 144b are accommodated, the intumescent material 146a, 146b is here applied as a coating in the sections 148a and 148b on the inside of the connecting piece 140, in its sections 148a, 148b. In these areas, no recesses are formed in this embodiment example, so that the intumescent material is present as an applied layer in the annular gap between the connecting piece and the inserted conduit.

FIGS. 16a, 16b and 16c show a 16th embodiment of the invention.

The corrugations 153a, 153b with the respective sealing means 154a, 154b are formed in a conventional manner on the connecting piece 150 in its insertion regions 155a, 155b. In this embodiment example, the intumescent material 156a, 156b is not placed on the connecting piece 150, but in recesses on the inserted conduit 151a or 151b. In this design, too, a connecting system is created by the interaction of the connecting piece 150 and the inserted conduits 151a and 151b, which places the intumescent material in the connection area, more precisely in the sections 158a and 158b between the connected components, after the crimped connection has been made. The recesses in the inserted conduit 151a, 151b can be formed analogue to the recesses in the connecting piece according to the previous descriptions, e.g. as corrugations, grooves, roughening or other recesses.

If no recesses are required at all, the intumescent material can be sprayed or even applied in liquid form to the inserted conduit to achieve a corresponding effect in accordance with the invention.

Several embodiments have been shown which represent a connecting piece into which conduit sections can be inserted. The specific design of the connecting piece is shown here merely as an example; the connecting piece can also be angled, have variable diameters or be designed in any other way, whereby the only important point in the context of the invention is how intumescent material is placed in recesses of the connecting piece in the connecting area.

1. A connecting piece made of metal for conduits, wherein the connecting piece has at least one cylindrical, tubular receiving section into which a conduit section can be inserted,
wherein the receiving section is designed at least partially as a deformable pressing section,
wherein at least one first corrugation is formed in the receiving section on the inside of the connecting piece along an inner circumference of the connecting piece,
wherein an elastic sealing means is introduced into the first corrugation, which at least partially fills the corrugation,
wherein
intumescent material, in particular expandable graphite material, is arranged at least in sections on the inside of the connecting piece in the receiving section.

2. The connecting piece according to claim 1, wherein the intumescent material is arranged at least partially in recesses in the inside of the connecting piece.

3. The connecting piece according to claim 2, wherein the intumescent material, in particular expandable graphite, is arranged at least partially in recesses which are formed by the first corrugation into which the sealing means is also placed.

4. The connecting piece according to claim 3, wherein the intumescent material, in particular expandable graphite, is arranged in the first corrugation between the sealing means and the wall material of the connecting piece.

5. The connecting piece according to claim 2, wherein a claw ring is arranged in the pressing section on the inside of the receiving section.

6. The connecting piece according to claim 5, wherein the intumescent material, in particular expandable graphite, is arranged adjacent to the claw ring or inside the claw ring.

7. The connecting piece according to claim 5, wherein the intumescent material, in particular expandable graphite, and the claw ring are arranged together with the elastic sealing means in the first corrugation.

8. The connecting piece according to claim 2, wherein a support ring is arranged next to the elastic sealing means, wherein the support ring is formed at least partially of intumescent material, in particular expandable graphite, or is coated therewith.

9. A connecting piece according to claim 2, wherein the intumescent material, in particular expandable graphite, is at least partially arranged in recesses which are formed by a second corrugation which is formed in the connecting piece offset in the axial direction of the receiving section.

10. A connecting piece according to claim 9, wherein the first and second corrugations are formed as adjacent, merging corrugations to form a double corrugation.

11. A connecting piece according to claim 2, wherein the intumescent material, in particular expandable graphite, is at least partially inserted as an annular body into an associated recess.

12. A connecting piece according to claim 2, wherein the intumescent material, in particular expandable graphite, is at least partially inserted as a film into an associated recess.

13. A connecting piece according to claim 2, wherein the intumescent material, in particular expandable graphite, is at least partially arranged in recesses which are formed by profiling and/or roughening the inside of the connecting piece in the receiving section.

14. A connecting piece according to claim 2, wherein the intumescent material, in particular expandable graphite, is arranged at least partially as a spray application or brush application, in particular as a varnish on the connecting piece.

15. A connecting piece according to claim 2, wherein the intumescent material, in particular expandable graphite, is arranged at least partially in the region of the connecting piece adjoining the receiving section on the end side, so that when a conduit section is inserted, the intumescent material adjoins an end side of the inserted conduit section.

16. A connecting system for conduits made of metal, with a connecting piece according to claim 1,
with a conduit section which is insertable into the tubular receiving section.

17. A connecting system for conduits made of metal, with a connecting piece which has at least one cylindrical, tubular receiving section,
with a conduit section which can be inserted into the tubular receiving section,
wherein the receiving section is at least partially formed as a deformable pressing section,
wherein at least one first corrugation is formed in the receiving section on the inside of the connecting piece along an inner circumference of the connecting piece,
wherein an elastic sealing means is placed in the first corrugation, which at least partially fills the first corrugation,
wherein
intumescent material, in particular expandable graphite material, is arranged at least in sections on the outside of the conduit section in the region which is insertable into the receiving section.

18. A connecting system according to claim 17, wherein the intumescent material is arranged on the conduit section as a spray application or as a brush application, in particular as a paint.

19. The connecting system according to claim 17, wherein the intumescent material is arranged on the conduit section in at least one recess which is formed on the outside of the conduit section.
